(19) United States
(12) Patent Application Publication
(10) Pub. No.: US 2022/0142181 A1
(43) Pub. Date: May 12, 2022

(54) Device for Cutting a Dough Sheet on a Substrate, in Particular a Conveyor

(71) Applicant: Radie B.V., Culemborg (NL)

(72) Inventor: Johannes Josephus Antonius Van Blokland, Laren (NL)

(21) Appl. No.: 17/501,416

(22) Filed: Oct. 14, 2021

(30) Foreign Application Priority Data
Nov. 10, 2020 (EP) 20206672.6

(51) Int. Cl. A21C 11/10; A21C 9/08

(52) U.S. Cl. CPC A21C 11/10; A21C 9/08

(57) ABSTRACT

The invention relates to a device for cutting a dough sheet on a substrate, in particular a conveyor, comprising a conveyor belt, for transporting the dough sheet in a transport direction, at least one cutting wheel, suspended above the conveyor belt, such that the circumference of the wheel touches a transporting surface of the conveyor belt, wherein the wheel has a diameter and a horizontal axis of rotation, which horizontal axis of rotation is beared in the suspension and wherein the diameter of the wheel is less than 40 mm, more preferably less than 30 mm, and even more preferably less than 20 mm.

The present invention relates to a device for cutting a dough sheet on a substrate, in particular a conveyor.

Devices for this purpose are well known in the art. When the dough is cut while being transported, rotating knives or cutting wheels may be used for making a cut in the transport direction, and a stationary chopper may be used for making a cut perpendicular to the transport direction. For creating more complex shaped cuts, a cutting roller with predetermined cutting shape, such as a triangle or trapezoid for creating a croissant, may be applied. When the dough is cut while it is stationary, a cutting wheel may be moved with respect to the dough sheet.

Alternatively, jet knives may be used in various cases, but these require specific circumstances and precautions in order to drain the cutting fluid.

However, also the cutting wheels according to the state of the art have disadvantages. Besides being unsuitable for cutting patterns with sharp edges, they tend to smear the dough, which results in undesired effects and irregularities in the dough products once baked.

It is a goal of the present invention to take away at least part of the above disadvantages, and/or to provide a useful alternative to the state of the art.

The invention thereto proposes a device for cutting a dough sheet on a substrate, in particular a conveyor, comprising a conveyor belt, for transporting the dough sheet in a transport direction, at least one cutting wheel, suspended above the conveyor belt, such that the circumference of the wheel touches a transporting surface of the conveyor belt, wherein the wheel has a diameter and a horizontal axis of rotation, which horizontal axis of rotation is beared in the suspension. and wherein the diameter of the wheel is less than 40 mm, more preferably less than 30 mm, and even more preferably less than 20 mm.

The actual size of the cutting wheel is chosen in dependency of the thickness of the dough sheet to be cut. With a given sheet thickness, the angle under which the dough is engaged by the cutting wheel depends on the diameter of the wheel. The inventors have found that when this angle is at least 35 degrees, but more preferably at least 45 degrees, a sharper cut with less damage and irregularities to the edges of the dough is obtained. It has also appeared that this goes for an angle with a maximum of 85 degrees, but more preferably a maximum of 75 degrees.

Is has also been determined that the vertical speed-component of the cutting operation that is relatively high when compared to a wheel with a larger diameter, contributes to a sharper cut.

In a preferred embodiment, a distance from the touching point of the wheel with the conveyor belt to the closest point of the suspension is at least half of the diameter of the cutting wheel minus 2 mm. This means, the bearing surrounds the horizontal axis of rotation of the wheel over only a very small distance, allowing the main part of the cutting wheel to submerge under the dough level of the sheet to be cut.

A thickness of the blade of the wheel will normally be between 1.5 and 2.5 mm, and in particular 2 mm, and an angle of the blade in cross section between 10 and 20 degrees, and in particular about 15 degrees.

The cutting wheel may be passively driven, that is, rotatable by means of friction with the conveyor belt in a transport direction. It has appeared in practice, that actively driving the wheel is not necessary, even if it is almost half under dough level.

The device according to the invention may further comprise a quick-release mechanism for exchanging the wheel, in particular for adapting the diameter of the wheel to the thickness of a dough sheet to be cut. Quick release in the sense of the present invention means that it can be released, or exchanged without any tools required.

In order to enable the cutting wheel to change directions, in a further embodiment, the cutting wheel is suspended rotatable about a vertical axis of rotation perpendicular to the transporting surface of the conveyor belt. As a result, the wheel can follow and cut any direction in the plane of the substrate and/or with respect to a direction of movement of the dough.

Preferably, the horizontal axis of rotation and the vertical axis of rotation cross each other and hence do not cut each other. Additionally, the vertical axis of rotation is preferably in the plane of the wheel.

That means, the axis of rotation that determines the direction leads or lags the wheel when rotating. This makes the cutting wheel “automatically follow” the suspension, in the way a shopping cart wheel does.

In a further embodiment, the cutting wheel is suspended tensioned, that is, with a tension toward the substrate. The tension may normally be a spring-tension, which is preferably adjustable.

The suspension may comprise a leg, extending between the horizontal and the vertical axis of rotation and the spring tension may be applied between the leg and a part of the suspension corresponding with the vertical axis.

The invention will now be elucidated with reference to the following figures. Herein:

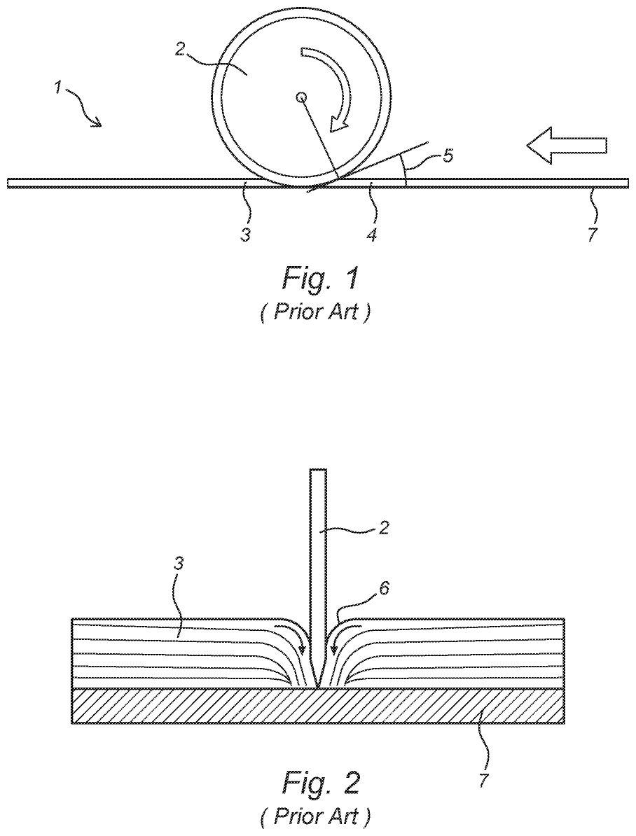

FIG. 1 shows a side view of a prior art cutting wheel cutting dough;

FIG. 2 shows a cross section of a prior art cutting wheel cutting dough;

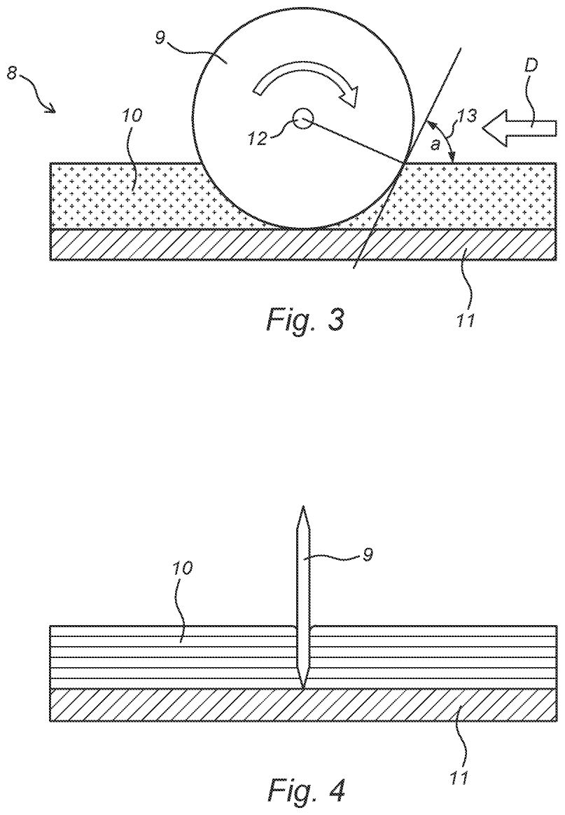

FIG. 3 shows a side view of a cutting wheel according to the invention cutting dough;

FIG. 4 shows a cross section of a cutting wheel according to the invention cutting dough;

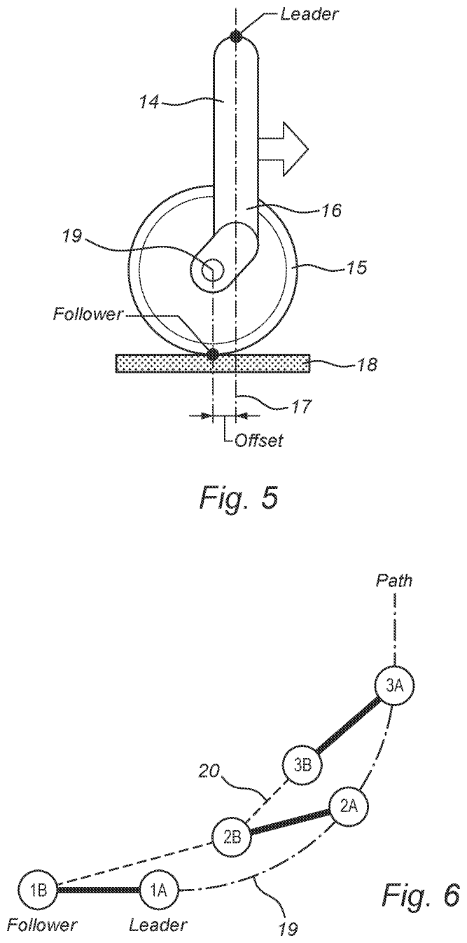

FIG. 5 shows a side view of a suspension according to the invention;

FIG. 6 shows a schematic detailed view of a path followed by a cutting wheel according the invention;

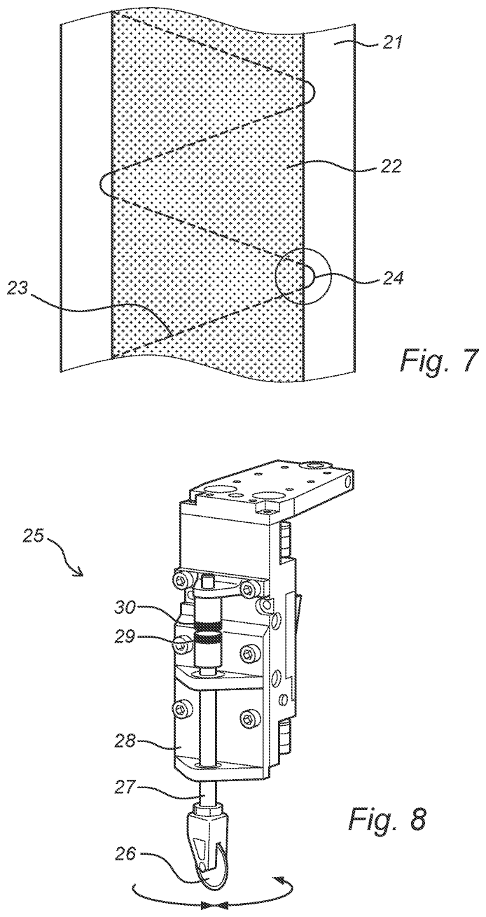

FIG. 7 shows a top view of a pattern that can be cut with a device according to the present invention; and

FIG. 8 shows a suspension according to an embodiment of the present invention.

FIG. 1 shows a side view 1 of a prior art cutting wheel 2 cutting dough 3. The cutting wheel has a diameter of about 80 mm. With a given thickness 4 of the dough sheet, which may in this example be for instance 2 mm, the angle 5 is about 20 degrees.

FIG. 2 shows a cross section of the configuration from FIG. 1. Visible is that the cut made in the dough is rounded at its upper side 6, instead of being sharp. This is the result of the topside of the dough being pressed along the cutting edge. In particular when the dough type comprises multiple layers, such as puff pastry for baking for instance croissants, this is found very disadvantageous. The cutting wheel exactly touches the substrate 7.

FIG. 3 shows a side view 8 of a cutting wheel 9 according to the invention, cutting dough 10. The device comprises a conveyor belt 11, for transporting the dough sheet in a transport direction D, at least one cutting wheel 9, suspended above the conveyor belt, such that the circumference of the wheel touches a transporting surface of the conveyor belt 11, wherein the wheel has a diameter and a horizontal axis of rotation, which horizontal axis of rotation is beared 12 in the suspension.

In this figure the dough sheet is 8 mm, and the cutting wheel has a diameter of 30 mm. As a result, the cutting angle 13 is 65 degrees. Keeping the cutting angle, that is, the angle under which the cutting wheel first touches the dough, within a certain interval, preferably between 45 and 75 degrees is the general purpose of the invention. Since the angle is the result of both the diameter of the wheel and the dough thickness, it is beneficial when the cutting wheel can be easily exchanged. A size of wheel that matches the dough sheet thickness can then be selected.

FIG. 4 shows a cross section of the cutting wheel from FIG. 3. The figure shows that increasing the angle of cutting has proved to reduce the amount of the topside dough that is pulled in by the cutting device substantially. Typically a cutting angle greater than 45 degrees result in sharp edged cuts. Depending on dough type however, the cutting angle limit is about 75 degrees. At this point the forward pushing force of the rotating cutting device may induce congestion in front of the top of the dough sheet.

FIG. 5 shows a side view of a suspension 14 according to the invention, wherein the cutting wheel 15 is further suspended 16 rotatable about a vertical axis of rotation 17 perpendicular to the transporting surface 18 of the conveyor belt 18. The horizontal axis of rotation 19 and the vertical axis of rotation 17 cross each other and hence do not cut each other. As a (desired) effect, the cutting wheel follows the direction of the suspension, so it allows to create curved paths, as depicted in FIG. 6. Also for this aspect of the invention, a small wheel diameter is desired.

The cutting wheel is preferably suspended pre-tensioned, or with a (bias) force in the direction of the conveyor belt. The tension or force may be adjustable. The tension may for instance be generated by a spring, a weight, or by a pair of magnets that are oriented in such way that they repel each other.

The suspension may comprise a leg, extending between the horizontal and the vertical axis of rotation and the spring tension may be applied between the leg and a part of the suspension corresponding with the vertical axis. Alternatively, the leg may be coupled rigidly to the vertical axis, and the pre-tension or force may act on the vertical axis of rotation.

FIG. 6 shows a schematic detailed view of a path 19 followed by a cutting wheel according to the invention, wherein it is visible that the actual cutting point follows the suspension, taking a shortcut 20. A controller for the device according to the invention may take this effect into account.

FIG. 7 shows a top view of a pattern that can be cut in a dough sheet 22 on a conveyor 21 with a device according to the present invention. In the figure, the cuts 23 are straight lines, but the cutting wheel is re-oriented fastly once it leaves the dough sheet, for making a U-turn 24 and then cutting the dough sheet diagonally in opposite direction. This is made possible by the small diameter of the cutting wheel itself.

FIG. 8 shows an alternative embodiment 25 of the present invention, for cutting a dough sheet on a substrate (not shown), with a cutting wheel 26, suspended above the substrate, such that the circumference of the wheel touches the substrate, wherein the wheel is suspended rotatably about a vertical axis of rotation, wherein the wheel is carried by a shaft 27 rotatable about the vertical axis with respect to a housing 28 in which it is beared, wherein the shaft is provided with a first magnet 29 and the housing is provided with a second magnet 30, positioned opposite to the first magnet 29 and wherein both magnets 29, 30 are oriented such that they repel each other, that is, with either both their north poles facing each other or with both their south poles facing each other. This suspension has the benefit over a construction with springs that a rotation of the cutting wheel about its vertical axis of rotation has the least possible friction. The features of this embodiment can be combined with any other feature mentioned in this application.

A suspension, in particular for a cutting wheel, comprising a first part and a second part that are rotatably connected to each other about an axis of rotation, and translatable parallel to the axis of rotation, wherein the first part and the second part each comprise a magnet, wherein the magnets are oriented with the repelling poles toward each other may be applied in embodiments of the invention.

1. Device for cutting a dough sheet on a substrate, in particular a conveyor, comprising:
A conveyor belt, for transporting the dough sheet in a transport direction;
At least one cutting wheel, suspended above the conveyor belt, such that the circumference of the wheel touches a transporting surface of the conveyor belt;
Wherein
The wheel has a diameter and a horizontal axis of rotation, which horizontal axis of rotation is beared in the suspension;
and wherein
The diameter of the wheel is less than 40 mm, more preferably less than 30 mm, and even more preferably less than 20 mm.

2. Device according to claim 1, wherein a distance from the touching point of the wheel with the conveyor belt to the closest point of the suspension is at least half of the diameter of the cutting wheel minus 2 mm.

3. Device according to claim 1, wherein the cutting wheel is passively driven, that is, rotatable by means of friction from the conveyor belt in a transport direction.

4. Device according to claim 1, comprising quick-release mechanism for exchanging the wheel, in particular for adapting the diameter of the wheel to the thickness of a dough sheet to be cut.

5. Device according to claim 1, wherein the cutting wheel is further suspended rotatable about a vertical axis of rotation perpendicular to the transporting surface of the conveyor belt.

6. Device according to claim 5, wherein the horizontal axis of rotation and the vertical axis of rotation cross each other and hence do not cut each other.

7. Device according to claim 1, wherein the cutting wheel is suspended pre-tensioned.

8. Device according to claim 7, wherein the tension is adjustable.

9. Device according to claim 1, wherein the suspension comprises a leg, extending between the horizontal and the vertical axis of rotation.

10. Device according to claim 7, wherein the spring tension is applied between the leg and a part of the suspension corresponding with the vertical axis.

11. Method for cutting a dough sheet on a substrate, in particular a conveyor, comprising:
Providing a dough on a substrate;
Cutting the dough by means of a cutting wheel;
Wherein
The diameter of the cutting wheel is chosen such that the angle under which the dough is engaged by the cutting wheel is at least 35 degrees, but more preferably at least 45 degrees.

12. Method according to claim 11, wherein the angle is less than 85 degrees, and more preferably less than 75 degrees.

13. Method according to claim 11, wherein the diameter of the wheel is less than 40 mm, more preferably less than 30 mm, and even more preferably less than 20 mm.
